(19) United States
(12) Patent Application Publication
(10) Pub. No.: US 2011/0318608 A1
(43) Pub. Date: Dec. 29, 2011

(54) TMR device with novel pinned layer

(75) Inventors: Hui-Chuan Wang, Pleasanton, CA (US); Kunliang Zhang, Fremont, CA (US); Tong Zhao, Fremont, CA (US); Min Li, Dublin, CA (US)

(73) Assignee: Headway Technologies, Inc.

(21) Appl. No.: 12/803,545

(22) Filed: Jun. 29, 2010

(51) Int. Cl. G11B 5/39; B05D 5/00

(52) U.S. Cl. 428/811.1; 427/127

(57) ABSTRACT

The invention discloses how the insertion of a layer of CoFeB serves to increase the robustness of an MTF device by smoothing the interface between the tunnel barrier and the pinned layer.

### FIELD OF THE INVENTION

The invention relates to the general field of magneto-resistive devices with special emphasis on reducing the R.A product without significant loss of device robustness.

### BACKGROUND OF THE INVENTION

It is well known that the reliability and performance of a tunneling magneto-resistance (TMR) sensor is strongly dependent on the quality its barrier layer. As the resistance.area product (R.A) grows smaller in today's high density magnetic recording applications, the corresponding barrier thickness has also to be reduced. For example, when the R.A is in the 1-3 ohm·μm² range, the barrier thickness will typically need to be in a range of from about 5 to 10 Å.

Referring now to FIG. 1, a typical tunneling magneto-resistance (TMR) sensor includes seed or buffer layer 11, antiferromagnetic (AFM) layer 12, outer pinned layer 13 (commonly referred to as anti-parallel 2 or AP2), AFM coupling layer 14—typically, but not limited to, Ru, inner pinned layer 15 (AP1), usually CoFe, dielectric barrier layer 16, free layer 17, and capping layer 18. CoFe is usually used for AP2 because of the strong exchange field (Hex) between CoFe and the AFM layer. (Most commonly, IrMn is used for the AFM layer in TMR sensors but it is to be understood that the invention disclosed below does not depend for its operation on any one particular AFM material).

A routine search of the prior art was performed with the following references of interest being found:

U.S. Patent Application 2008/0316657 (Zhang et al—Headway) teaches an AP2 pinned layer comprising CoFe/insertion layer/CoFe where the insertion layer can be CoFeB. This was found to improve the exchange field between CoFe and the AFM layer, as well as the sensor smoothness, no consideration having been given to its effect on the robustness of the device.

U.S. Patent Application 2009/0269617 (Zhang et al—Headway) shows a pinned layer comprising three FeCo layers.

U.S. Pat. No. 7,525,166 (Hosomi et al) discloses a pinned layer having a stacked structure where Co, Cofe, CoFeB may be used.

U.S. Pat. No. 7,602,033 (Zhao et al—Headway) shows an inner pinned layer of CoFeB/Fe/Co and an outer pinned layer of CoFe. U.S. Pat. No. 7,616,475 (Yamamoto et al) teaches a pinned layer can be a stacked structure of Co, CoFe, CoFeB, or the like. Ru can be between magnetic stacks.

### SUMMARY OF THE INVENTION

It has been an object of at least one embodiment of the present invention to increase the density of MTJ devices in an MRAM.

Another object of at least one embodiment of the present invention has been to be able to reliably manufacture devices whose barrier thickness is in the 5 to 10 Å range.

Still another object of at least one embodiment of the present invention has been to provide a smooth interface for the underside of the barrier layer.

These objects have been achieved by inserting an amorphous layer of CoFeB within the pinned layer (generally, but not necessarily, CoFe)

### BRIEF DESCRIPTION OF THE DRAWINGS

FIG. 1 is a cross-sectional view of a typical TMR device of the prior art.

FIG. 2 shows the device of FIG. 1 in which the AP2 layer has been modified as disclosed below.

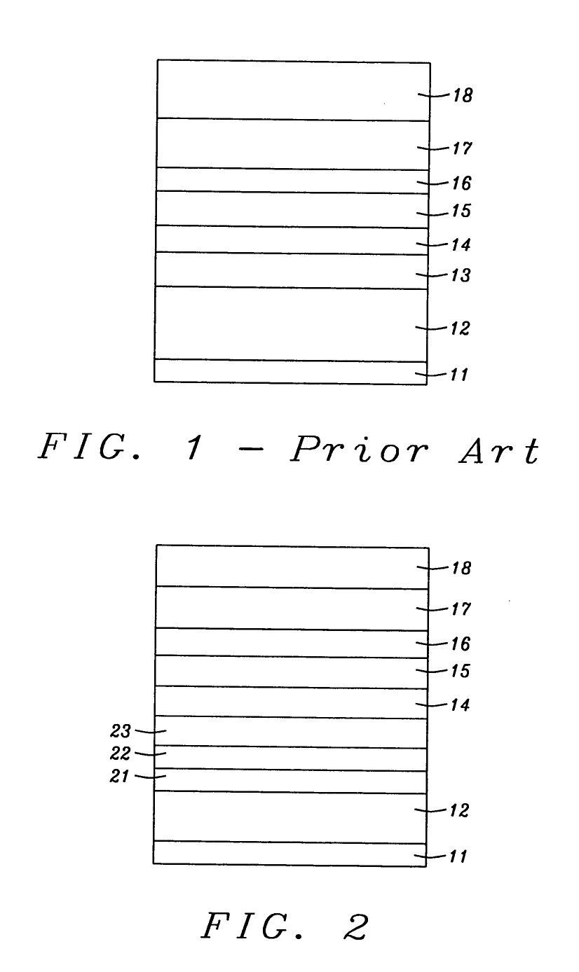

### DESCRIPTION OF THE PREFERRED EMBODIMENTS

As noted earlier, the quality of the barrier layer is of great importance. A key factor that is critical for controlling this quality is the smoothness of the film that underlies the barrier layer. The invention discloses how the smoothness of AP2 can be improved without diminishing the strong exchange field (Hex), between AP2 and the AFM layer, that was discussed above.

The required improvement in AP2 is accomplished by inserting, within the standard CoFe layer normally used for AP2, amorphous layer 22 of (CoFeₓ)B_{y} (with x ranging from 0.1 to 0.7, with a range of from 0.1 to 0.5 being preferred, and y ranging from 0.05 to 0.4 with a range of from 0.15 to 0.3 being preferred). The thickness of this inserted layer should be in a range of from 3-15 Å, with from 4-10 Å being preferred. The resulting AP2 structure, as illustrated in FIG. 2, is thus: (CoFe)ₒᵤₜₑᵣ 21/(CoFeₓ) B_{y} 22/(CoFe)ᵢₙₙₑᵣ 23, with (CoFe)ₒᵤₜₑᵣ being closest to the AFM layer, as shown. The inserted amorphous CoFeB layer 23 serves to reduce the influence of (CoFe)ₒᵤₜₑᵣ on the crystallinity of CoFe)ᵢₙₙₑᵣ while at the same time compensating for surface roughness originating at the underlying IrMn material that is used for the AFM layer.

The invention leaves AP1 unchanged.

In order to confirm the effectiveness of the above arrangement, we compared the interlayer coupling, Hin, of a GMR (giant magneto-resistance) stack with and without an inserted amorphous CoFeB layer. The value of Hin was derived from its B-H loop. The Hin value of a GMR (and similarly a TMR) stack is known to increase monotonically with film roughness, making it a suitable measure of the underlayer roughness.

TABLE I compares the interlayer coupling (Hin) for the pinned layer portion of a GMR stack where the pinned layer is CoFe only and where the pinned layer is CoFe/CoFeB/CoFe. The full structure on which the TABLE I data is based was:

TABLE I
Ta50/Ru50/IrMn70/Pinned Layer/Cu25/CoFe10/NiFe70/Ru50

| Pinned Layer | Hin (Oe) | |
|---|---|---|
| 18A CoFe-25% | 27.01 | Reference |
| 7A CoFe-25%/6A (CoFe-25%)B/7A CoFe-25% | 18.33 | |

The data presented in TABLE I shows that Hin has been reduced by ⅓, confirming that the pinned layer did become smoother after a thin CoFeB layer was inserted within the original CoFe pinned layer.

TABLE II compares Hex, Hc, and Hex/Hc [PLEASE DEFINE Hc] for the pinned layer portion of a GMR stack with CoFe only and a GMR stack having a CoFe/CoFeB/CoFe AP2 pinned layer.

The full structure on which the TABLE II data is based was:

TABLE II
Ta50/Ru50/IrMn70/Pinned Layer/Ru50

| | Hex | | | |
|---|---|---|---|---|
| Pinned Layer | (Oe) | Hc (Oe) | Hex/Hc | |
| 18A CoFe(25%) | 2184 | 337 | 6.5 | Reference |
| 7A CoFe-25%/6A (CoFe-25%)B/ | 2105 | 345 | 6.1 | |
| 7A CoFe-25% | | | | |

The data in TABLE II demonstrates that the changes made to AP2 by the invention do not significantly affect the exchange properties of the overall device. Thus, the invention provides us with a TMR device that is more robust, making it possible to build TMR sensors having a low R.A value (i.e. having a thinner barrier layer) without sacrificing reliability and/or performance.

We note here that the general principles of the invention may be applied with equal effect to similar spintronic devices such as CPP (current perpendicular to plane) GMR devices, dual spin valves, etc. [ANY OTHERS?].

What is claimed is:

1. A method for improving robustness of a TMR (tunneling magneto-resistive) device having a pinned layer, comprising:
providing an antiferromagnetic (AFM) layer on a seed layer;
depositing a first layer of CoFe on said AFM layer;
depositing an amorphous layer of (CoFeₓ)B_{y} on said first layer of CoFe;
depositing a second layer of CoFe on said amorphous layer of (CoFeₓ)B_{y}, thereby completing formation of AP2;
depositing an AFM coupling layer on said second layer of CoFe;
depositing an AP1 layer on said AFM coupling layer;
depositing a barrier layer on said AP1 layer;
depositing a free layer on said barrier layer; and
depositing a capping layer on said free layer.

2. The method recited in claim 1 wherein said first layer of CoFe is deposited to a thickness that is in a range of from 5 to 15 Å.

3. The method recited in claim 1 wherein said second layer of CoFe is deposited to a thickness that is in a range of from 5 to 15 Å.

4. The method recited in claim 1 wherein said amorphous layer of (CoFeₓ)B_{y} is deposit. 5d to a thickness that is in a range of from 3 to 15 Å.

5. The method recited in claim 1 wherein said barrier layer is deposited to a thickness that is in a range of from 5 to 10 Å whereby said TMR device has a resistance.area product (R.A) that is in a range of from 0.5 to 5 ohm·μm².

6. The method recited in claim 1 wherein, for said amorphous layer of (CoFeₓ)B_{y}, x is in a range of from 0.1 to 0.7 and y is in a range of from 0.05 to 0.4.

7. The method recited in claim 1 wherein interlayer coupling within said pinned layer is reduced by about ⅓.

8. The method recited in claim 1 wherein exchange coupling within said pinned layer is reduced by less than 4%.

9. An improved TMR (tunneling magneto-resistive) device having a pinned layer, comprising:
an antiferromagnetic (AFM) layer on, and contacting, a seed layer;
a first layer of CoFe on, and contacting, said AFM layer;
an amorphous layer of (CoFeₓ)B_{y} on, and contacting, said first layer of CoFe;
a second layer of CoFe on, and contacting, said amorphous layer of (CoFeₓ)B_{y};
said first layer of CoFe, said amorphous layer, and said second layer of CoFe constituting an AP2 layer;
an AFM coupling layer on, and contacting, said second layer of CoFe;
an AP1 layer on, and contacting, said AFM coupling layer;
a barrier layer on, and contacting, said AP1 layer;
a free layer on, and contacting, said barrier layer; and
a capping layer on, and contacting, said free layer.

10. The TMR device described in claim 9 wherein said first layer of CoFe has a thickness that is in a range of from 5 to 15 Å.

11. The TMR device described in claim 9 wherein said second layer of CoFe has a thickness that is in a range of from 5 to 15 Å.

12. The TMR device described in claim 9 wherein said amorphous layer of (CoFeₓ)B_{y} has a thickness that is in a range of from 3 to 15 Å.

13. The TMR device described in claim 9 wherein said barrier layer has a thickness that is in a range of from 5 to 10 Å whereby said TMR device has a resistance.area product (R.A) that is in a range of from 0.5 to 5 ohm·μm².

14. The TMR device described in claim 9 wherein, for said amorphous layer of (CoFeₓ)B_{y}, x is in a range of from 0.1 to 0.7 and y is in a range of from 0.05 to 0.4.

15. The TMR device described in claim 9 wherein interlayer coupling within said pinned layer has been reduced by about ⅓.

16. The TMR device described in claim 9 wherein exchange coupling within said pinned layer has been reduced by less than 4%.
